(19) United States
(12) Patent Application Publication
(10) Pub. No.: US 2006/0054739 A1
(43) Pub. Date: Mar. 16, 2006

(54) Turbofan or turbojet arrangement for vehicles, craft, aircraft and the like

(76) Inventors: Francisco Angel Perez, Almeria (ES); Manuel Saiz, Almeria (ES)

Correspondence Address: ROBERT M. SCHWARTZ, P.A., P.O. BOX 221470, HOLLYWOOD, FL, 33022, US

(21) Appl. No.: 11/226,983

(22) Filed: Sep. 15, 2005

(30) Foreign Application Priority Data
Sep. 15, 2004 (ES) P200402306
Aug. 18, 2005 (ES) P200502180

(51) Int. Cl. B64D 27/00

(52) U.S. Cl. 244/55

(57) ABSTRACT

The present invention is turbofan or turbojet assembly for vehicles, craft, aircraft and the like. The assembly includes a plurality of gas turbines, mini-turbines, micro-turbines or nanoturbines disposed in parallel. The turbines form a gondola that is a large, single turbine.

### BACKGROUND OF THE INVENTION

1. Field of the Invention

To drive vehicles, craft, aircraft and the like.

2. Description of the Prior Art

At present, large turbines are used whose performance is limited and less reliable due to their limitations. The following invention reduces or improves this.

### DESCRIPTION OF THE INVENTION

The turbofan or turbojet arrangement for vehicles, craft, aircraft and the like in the invention involves the installation of two or more gas turbines, mini-turbines, micro-turbines or nanoturbines grouped in parallel to form a single gondola and allowing for different configurations, based essentially on the concomitant simultaneous juxtaposition of said turbines, mini-turbines, micro-turbines and nanoturbines to form a large, single turbine which magnifies the vehicles' specifications, such as power, height, speed, range, etc.

In turn, each vehicle can carry several of these gondolas or turbines, mini-turbines, etc., groups.

The turbine, mini-turbine, etc., are secured together by their housings and associated studs or screws, and a single surrounding lateral fairing can be added. In addition to the circular fairing on the turbines, mini-turbines, etc., and their fans, they can be covered by just one fairing.

Although the number of gas turbines, mini-turbines, etc., to be used by each group is variable, most typically between 4 and 10 are used.

The gas turbines, mini-turbines, etc. are not only independent and produce thrust, lubrication, electricity, hydraulic and air pressure, but can also drive motor-pumps, compressors, generators, etc. independent of those turbines, mini-turbines, etc. Thus the turbines, mini-turbines, etc., can be used complete or without their fans, electrical generators, or hydraulic or oil pumps.

In such cases, change of turbines, mini-turbines, etc., due to failure, or for maintenance, etc., is extremely rapid.

By centralising the turbines, mini-turbines, etc., rotation using a planetary reducer system or the like, a single large fan can be driven.

Some or all of the turbines, mini-turbines, etc., can be tiltable.

Flow reversers and deflectors may be added.

A rapid dismantling system may be provided.

Layout may be such as to form the rear, front or cross shape of a fuselage or a piece/section of a wing, with a given number of such turbines, mini-turbines, etc.; this will be done mainly with a peripheral or cross-section circular, oval, rectangular or segmented and can use also arch form.

Running half the turbines, mini-turbines, etc., or their fans in one direction and the other half in the opposite direction eliminates the rotation torque created in existing turbines. With a large common fan, flow straighteners can be used, or for the different groups' fans to run in the opposite direction.

During cruising flight and particularly at the end of a flight, when weight is reduced, some of these turbines, mini-turbines, etc., can be stopped, leading to financial savings, and their rate can also be reduced.

For circular crown layouts, the central area can be used for other functions, such as an aircraft fuselage.

Advantages: Increased performance and power and, consequently, increased altitude capacity, speed, reduced costs, increased reliability, in case of failure the whole is hardly affected, rotary torque is eliminated, they are very economical, and easy to replace or repair.

Other features which are considered as characteristic for the invention are set forth in the appended claims.

Although the invention is illustrated and described herein as embodied in a turbofan or turbojet arrangement, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of specific embodiments when read in connection with the accompanying drawings.

### BRIEF DESCRIPTION OF THE DRAWINGS

FIG. 1 shows a front plan view of the arrangement according to the present invention;

FIG. 2 shows a rear plan view of the arrangement according to the present invention;

FIG. 3 shows a front plan view of another embodiment of the arrangement according to the present invention;

FIG. 4 shows a top plan view of another embodiment of the arrangement according to the present invention;

FIG. 5 shows a side elevational view of the arrangement according to FIG. 1;

FIG. 6 shows a rear plan view of another embodiment of the arrangement according to the present invention;

FIG. 7 shows a front plan view of another embodiment of the arrangement according to the present invention;

FIG. 8 shows a partial perspective view of a gear reducer according to the present invention;

FIGS. 9 to 14 show front plan views of different embodiments of nacelles;

FIG. 15 shows a side elevational view of another embodiment of the present invention;

FIG. 16 shows a side elevational view of another embodiment of the arrangement according to the present invention; and

FIGS. 17 to 21 show a front plan view of different embodiments of nacelles according to the present invention.

### DESCRIPTION OF THE PREFERRED EMBODIMENTS

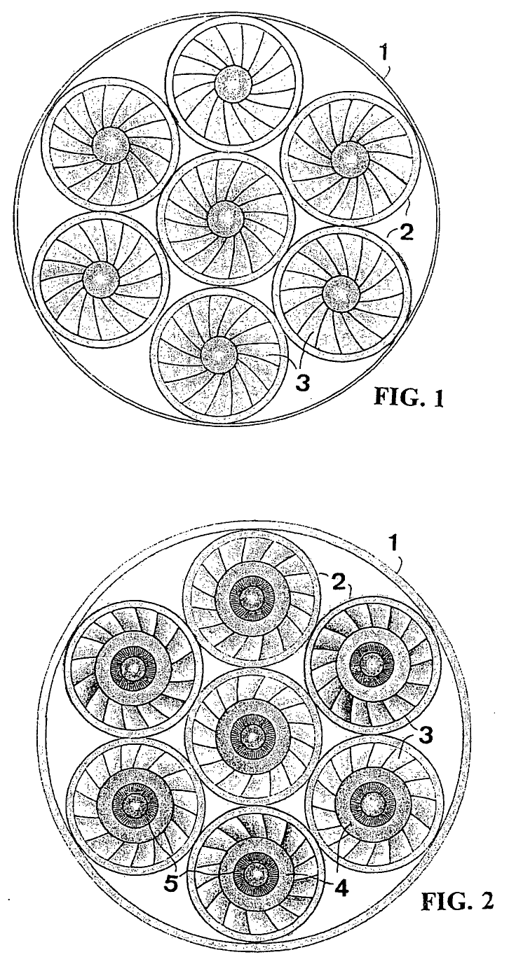

FIG. 1 shows the cowl 1, turbines, mini-turbines, micro-turbines or nanoturbines 2 and their fans 3. It shows a circular arrangement with seven turbines, microturbines, etc. three running in one direction and the other four in the opposite direction. The fairing is standard, each turbine, miniturbine, etc. with its fan.

FIG. 2 shows the cowl 1, turbines, mini-turbines, micro-turbines or nanoturbines 2 and their fans 3, nacelles of the turbines, micro-turbines, etc., 4 and the turbines blades 5. It shows the rear view of the arrangement shown in FIG. 1.

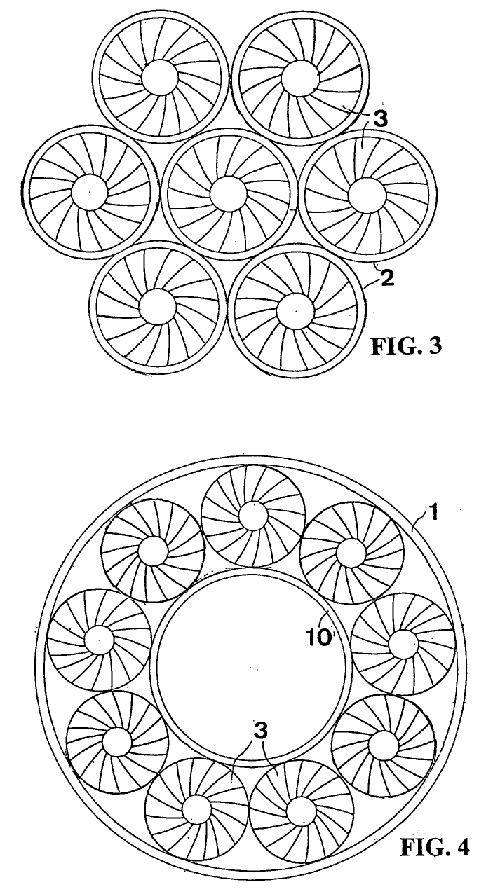

FIG. 3 shows the turbines, microturbines, etc. 2 and their fans 3 having individual cowls.

FIG. 4 shows the external common single lateral fairing of the fans 1, the fans 3 and the internal lateral fairing 10. It uses a circular crown arrangement.

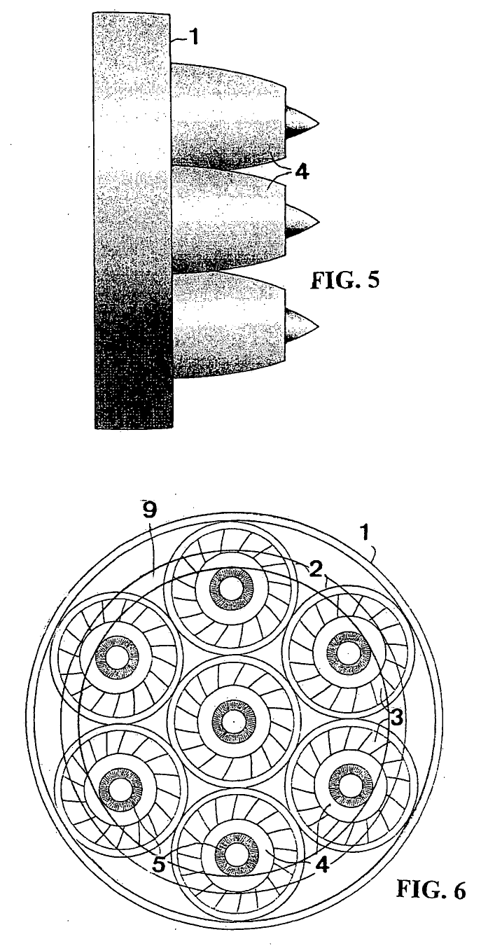

FIG. 5 shows the external fairing of the fans 1, the nacelles 4 of the turbines, microturbines, etc. It shows a side view of the arrangement shown in FIG. 1.

FIG. 6 shows a rear view of the cowl 1, turbines, mini-turbines, micro-turbines, etc. 2, their fans 3, nacelle 4 of the turbines, micro-turbines, etc., turbine blades 5 etc. and a cowl 9 that covers the nacelles 4 of the turbines, micro-turbines, etc.

FIG. 7 shows the cowl 1 of the turbines 8 and blades of the fan 7. It is of the single, big fan, in this case the turbines, micro-turbines, etc. do not use their fans.

FIG. 8 is a portion of a gear reducer system, which uses a planetary gear.

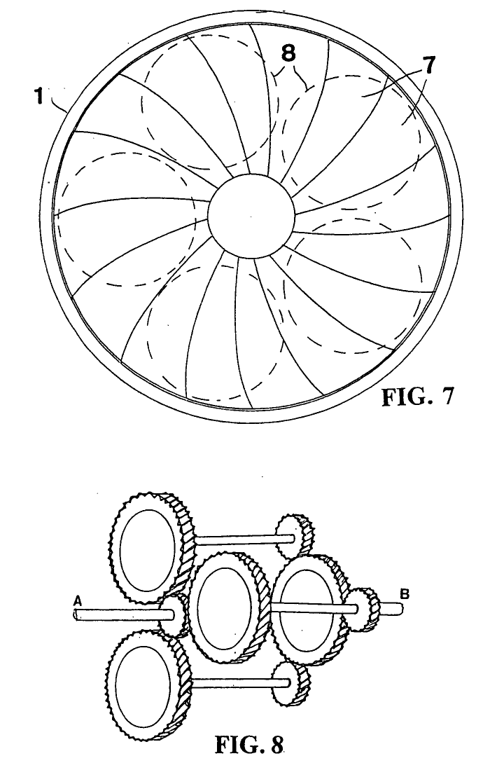

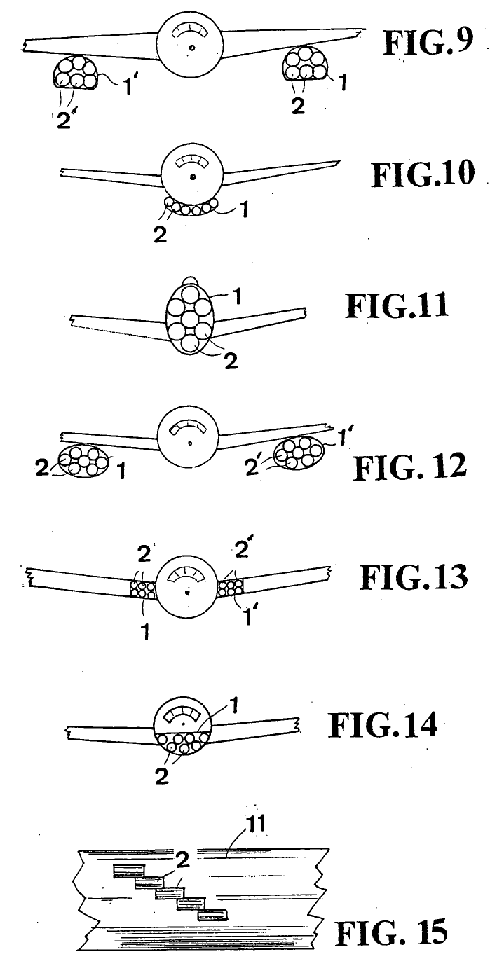

FIG. 9 shows nacelles disposed in a cowl 1 and 1′ having a cross-section that is in the form of a segment and turbines 2 and 2′.

FIG. 10 shows a group of nacelles disposed in a cowl 1 having a cross-section that is in the form of an arch and the turbines 2.

FIGS. 11 and 12 show a group of nacelles disposed in a cowl 1 having a cross-section that is in the form of an oval and the turbines 2 and 2′.

FIG. 13 shows a group of nacelles disposed in a cowl 1 and 1′ having a cross-section that is rectangular and the turbines 2 and 2′.

FIG. 14 shows a group of nacelles disposed in a cowl 1 having a cross-section in the form of a segment and the turbines 2.

FIG. 15 shows a portion of fuselage 11 and the turbines 2 arranged stepped.

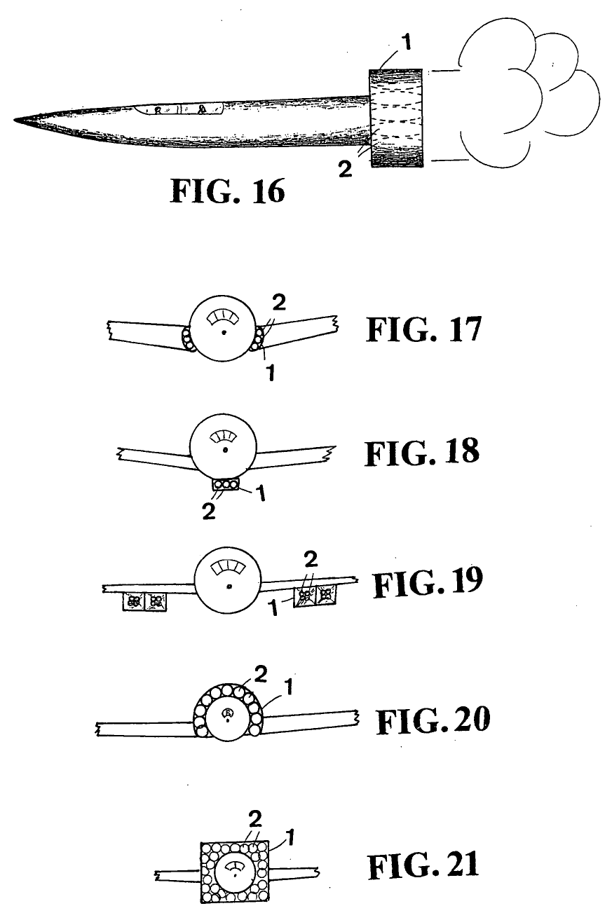

FIG. 16 includes a group of nacelles 4 of the circular crown type with the fuselage inside and the turbines, micro-turbines 2.

FIG. 17 shows a group of nacelles disposed in a cowl 1 having a cross-section that is the form of side arches and the turbines 2.

FIG. 18 shows a group of nacelles disposed in a cowl 1 having a cross-section that is rectangular in the lower zone of the fuselage and the turbines 2.

FIG. 19 shows a group of nacelles arranged below the wings and disposed in a cowl 1 having a cross-section that is rectangular and the turbines 2.

FIG. 20 shows a group of nacelles disposed in a cowl 1 having a cross-section that is in the form of an arch of circular crown and the turbines 2.

FIG. 21 shows a group of nacelles disposed in a cowl 1 having a cross-section is squared and are arranged around the fuselage, and the turbines 2.

This application claims the priority, under 35 U.S.C. § 119, of Spanish patent application P200402306 filed Sep. 15, 2004 and Spanish patent application P200502180 filed Aug. 18, 2005; the entire disclosure of the prior applications are herewith incorporated by reference.

I claim:

1. A turbofan or turbojet assembly for vehicles, craft, aircraft and the like, the assembly comprising:
a plurality of gas turbines, mini-turbines, micro-turbines or nanoturbines disposed in parallel forming a gondola being a large, single turbine.

2. The assembly according to claim 1, wherein the vehicle includes plurality of said gondolas.

3. The assembly according to claim 1, wherein said turbines have housings, said turbines are secured together by their housings and associated studs or screws, and a single surrounding lateral fairing is attached to said housings.

4. The assembly according to claim 1, wherein said turbines have fans, said turbines and fans are disposed in a single fairing.

5. The assembly according to claim 1, wherein said turbines are independent and produce thrust, lubrication, electricity, hydraulic and air pressure.

6. The assembly according to claim 1, wherein said turbines drive motor-pumps, compressors, generators, etc. independent of said turbines.

7. The assembly according to claim 1, further comprising a planetary reducer system for centralizing said turbines rotation, and a single large fan driven by said planetary reducer system.

8. The assembly according to claim 1, wherein said turbines are tiltable.

9. The assembly according to claim 1, further comprising flow reversers and deflectors.

10. The assembly according to claim 1, wherein said turbines are disposed in a layout that adopts a front shape of a fuselage.

11. The assembly according to claim 1, wherein said turbines are disposed in a shape that adopts the rear shape of a fuselage.

12. The assembly according to claim 1, wherein half of said turbines have fans running in one direction and the other half of said turbines have fans running in the opposite direction.

13. The assembly according to claim 1, further comprising a large common fan and flow straighteners.

14. The assembly according to claim 1, wherein said turbines have a circular cross-section.

15. The assembly according to claim 1, wherein said turbines are disposed in a circular crown cross-section.

16. The assembly according to claim 1, wherein said turbines are disposed in an oval cross-section.

17. The assembly according to claim 1, wherein said turbines are disposed in a rectangular cross-section.

18. The assembly according to claim 1, wherein said turbines are disposed in a segment cross-section.

19. The assembly according to claim 1, wherein said turbines are disposed in an arch cross-section.

20. The assembly according to claim 1, wherein said turbines are arranged in different steps.

21. The assembly according to claim 15, wherein a central area of the circular crown formed with said turbines is used to attach to a fuselage of the vehicle.

22. The assembly according to claim 1, wherein said turbines are disposed in a segment of circular crown cross-section surrounded with a portion of a fuselage of the vehicle.

23. The assembly according to claim 1, wherein said turbines are disposed in a cross-section that is squared and surrounds a fuselage of the vehicle.

24. The assembly according to claim 1, wherein said turbines are disposed in a shape that adopts a front shape of a wing section.
